(19) United States
(12) Patent Application Publication
(10) Pub. No.: US 2025/0364156 A1
(43) Pub. Date: Nov. 27, 2025

(54) Magnetic Data Cable

(71) Applicant: WENYONG YUE, SHENZHEN (CN)

(72) Inventor: WENYONG YUE, SHENZHEN (CN)

(21) Appl. No.: 18/777,482

(22) Filed: Jul. 18, 2024

(30) Foreign Application Priority Data
May 27, 2024 (CN) 2024211653956

(51) Int. Cl. H01B 7/08; H01B 3/30; H01B 3/50; H01B 7/02; H01B 11/00; H01F 7/02

(52) U.S. Cl. CPC H01B 7/0807; H01B 3/30; H01B 3/50; H01B 7/0216; H01B 7/0266; H01B 11/00; H01F 7/0215; H01F 7/0221

(57) ABSTRACT

A magnetic data cable is disclosed, including cable body and a data interface connected to both ends of the cable body. The cable body includes a cored wire group and an external protective layer wrapped outside of the cored wire group, a flexible magnetic strip is provided in the outer protective layer, and the flexible magnetic strip is located alongside of the cored wire group and extends parallel to the cored wire group. It is convenient to adjust diameter of the coil after the data cable has been coiled so as to facilitate storing of the data cable, and it is easy to operate.

### TECHNICAL FIELD

The present application relates to the technical field of data cables, and in particular to a magnetic data cable.

### BACKGROUND

Data cables are commonly used as charging components for electronic devices, and the data cables are long in length and are generally stacked and twisted together when carried, so that the data cables often need to be unraveled when in use, which is troublesome, and also has an unattractive appearance as well as take up space. Existing data cables on the market generally have the defect of inconvenient storage, and when the data cables in an idle state, due to the flexible nature of data cables, the data cables in the storage state appears messy, especially in some application scenarios that need to store the data cables in handbags, pockets, backpacks, and other narrow space. Messy data cables not only encroach on a larger storage space, but also seriously affect the user to take other items in the same space, therefore it is inconvenient to use, and also has a very cluttered visual and a poor experience.

In order to facilitate storage of the data cables, a magnetic storage data cable has appeared.

For example, Chinese patent CN212392445U discloses a magnetic storage data cable, wherein the wire is sleeved with a magnet block, and the data cable is folded and curled by using the magnet block to mutual magnetic attraction for storage.

For another example, Chinese patent CN211655236U discloses a magnetic storage data cable, wherein more than one magnetic suction portions are provided on the wire body, the wire body is coiled into a loop shape and stacked together for storage, and the magnetic suction portions between the upper and lower layers are suctioned to each other to position the coiled wire body after being coiled.

For another example, Chinese patent CN213717212U discloses a magnetic data cable with easy to store, wherein the data cable body is sleeved with a magnetic ring. When it is necessary to store the data cable, the data cable may be neatly stored by means of the magnetic ring.

However, in the technical solutions disclosed in the above existing patents, when the data cable is coiled for storage, the data cable between the upper and lower layers after being coiled is suctioned and positioned for coiling by means of the magnetic suction portions (or the magnet block, or the magnet ring). When coiling, the magnetic suction portions (or the magnet block, or the magnet ring) between the upper and lower data cable need to be aligned so as to be suctioned. Therefore, the operations are more cumbersome when coiling, and it is not easy to control the diameter of the coiled data cable due to the limitation of the distance of the magnetic suction portions (or the magnet block, or the magnet ring).

In addition, although the magnet ring is used in the existing technologies, in order to ensure the strength of the magnetic ring, the wall of the magnetic ring needs to be 1.5 mm or more, then the overall diameter of the data cable will increase by more than 3 mm, in a case of the same conductive parameters, which leads to a much larger diameter and a much heavier weight of the data cable.

Therefore, it is necessary to improve the current magnetic data cables.

### SUMMARY

In view of the above, the present disclosure aims to provide a magnetic data cable to effectively solve problems of troublesome operation of the current magnetic data cables.

To achieve above objectives, the present disclosure adopts following technical solutions. In some embodiments of the present disclosure, a magnetic data cable is provided, including a cable body and a data interface connected to both ends of the cable body. Herein the cable body includes a cored wire group and an external protective layer wrapped outside of the cored wire group, a flexible magnetic strip is provided in the outer protective layer, and the flexible magnetic strip is located alongside of the cored wire group and extends parallel to the cored wire group.

Preferably, the cored wire group is provided with two, and the flexible magnetic strip is located between two cored wire groups.

Preferably, the cable body has a rectangular cross-section, the cored wire group has a circular cross-section, and the flexible magnetic strip has a rectangular cross-section.

Preferably, the cored wire group includes an inner protective layer and a plurality of cored wires disposed within the inner protective layer, and the number of cored wire in the cored wire group is 2 to 4.

Preferably, the inner protective layer is made of plastic.

Preferably, the external protective layer is a woven mesh layer formed by weaving fabrics.

Preferably, the flexible magnetic strip separates the external protective layer to form two chambers, the cored wire group is provided with two, and two cored wire groups are located in the two chambers respectively.

Preferably, the cored wire group comprises a plurality of cored wires arranged side by side, and plastic is filled between an outer wall of the plurality of cod wires and an inner wall of the chambers.

Preferably, the cored wire group includes a plurality of flattened cored wires, and the flattened cored wires are arranged around outer peripheral sides of the flexible magnetic strip.

Preferably, the data interface is a USB Type-C data interface, a lightning data interface, or an Audio data interface.

The magnetic data cable of the present disclosure has obvious advantages and beneficial effects compared with the existing technologies, specifically, the following advantages are known from the above technical solutions.

By setting of the flexible magnetic strip in the external protective layer, so as to make the flexible magnetic strip locate alongside of the cored wire group and extend parallel to the cored wire group. When coiling the data cable to form a coil, the upper and lower layers of the cable body, or adjacent layers of the cable body are mutual magnetic attraction by means of the flexible magnetic strip. Since the flexible magnetic strip extends parallel to the cored wire group, it can adjust the size of the diameter of the coil after the data cable has been coiled without being obstructed, and also without being limited by the distance of the magnetic suction portions (or magnet block, or magnet ring) in the existing technologies. Thus it is convenient to adjust diameter of the coil after the data cable has been coiled so as to facilitate storing of the data cable, and it is easy to operate.

### BRIEF DESCRIPTION OF THE DRAWINGS

FIG. 1 shows a stereoscopic schematic diagram of a magnetic data cable in accordance with a first preferred embodiment of the present disclosure.

FIG. 2 shows a stereoscopic schematic diagram from another angle of the magnetic data cable in accordance with the first preferred embodiment of the present disclosure.

FIG. 3 shows a cross-section view of the magnetic data cable in accordance with the first preferred embodiment of the present disclosure.

FIG. 4 shows a cross-section view of the magnetic data cable in accordance with a second preferred embodiment of the present disclosure.

FIG. 5 shows a cross-section view of the magnetic data cable in accordance with a third preferred embodiment of the present disclosure.

FIG. 6 shows a stereoscopic schematic diagram of a magnetic data cable in accordance with a fourth preferred embodiment of the present disclosure.

In the drawings, reference signs are as follows. 10. Cable body, 11. Cored wire group, 111. Inner protective layer, 112. Cored wire, 113. Cored wire, 114. Flattened cored wire, 12. External protective layer, 13. Flexible magnetic strip, 14. Plastic, 101. Chamber, 20. Data interface.

### DETAILED DESCRIPTION OF THE EMBODIMENTS

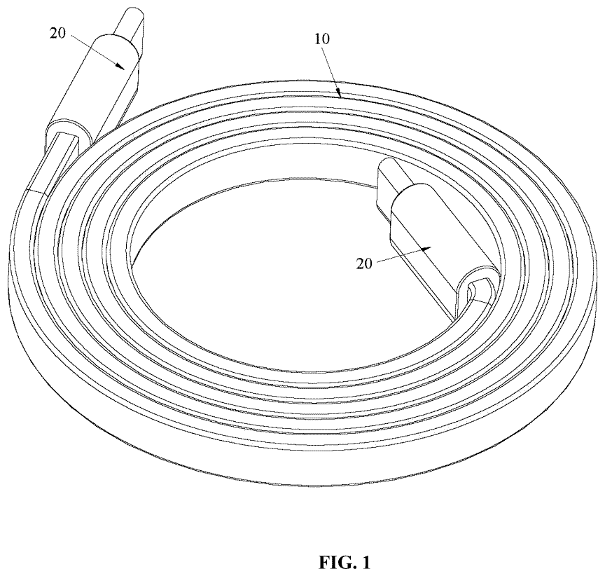

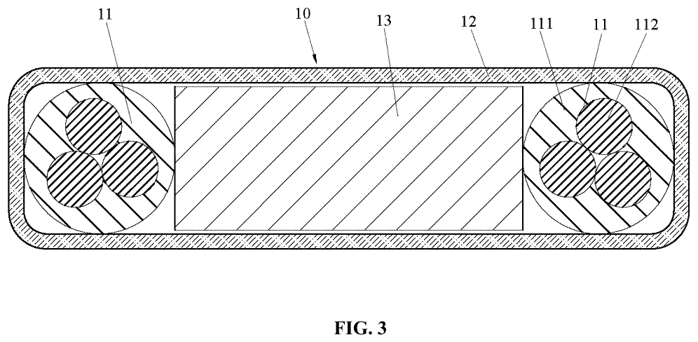

Referring to FIG. 1 to FIG. 3, it shows a specific structure of a magnetic data cable in accordance with a first preferred embodiment of the present disclosure, the magnetic data cable includes a cable body 10 and a data interface 20 connected to both ends of the cable body 10.

The cable body 10 includes a cored wire group 11 and an external protective layer 12 wrapped outside of the cored wire group 11. The cored wire group 11 includes an inner protective layer 111 and a plurality of cored wires 12 disposed within the inner protective layer 111. Moreover, a flexible magnetic strip 13 is provided in the outer protective layer 12, and the flexible magnetic strip 13 is located alongside of the cored wire group 11 and extends parallel to the cored wire group 11. In the first embodiment, the cored wire 11 is provided with two, and the flexible magnetic strip 13 is located between two cored wire groups 11. The cable body 10 has a rectangular cross-section, the cored wire group 11 has a circular cross-section, and the flexible magnetic strip 13 has a rectangular cross-section. By such designs, it makes the magnetic data cable of the present disclosure has a compact structure and is easy to coil. Furthermore, the number of cored wire in the cored wire group is preferably 2 to 4, but not limited to this. In addition, the external protective layer 12 is a woven mesh layer formed by weaving fabrics, the fabrics is used to form the woven mesh layer to enhance the toughness of the entire data cable to avoid the data cable being pulled off. Further, the inner protective layer 111 is made of plastic to better protect the plurality of cored wires 112.

The data interface 20 is a USB Type-C data interface. Of course, the data interface 20 may also be a lightning data interface. In addition, the data interface 20 may also be an Audio data interface, but not limited to this.

A method for using the magnetic data cable of the first embodiment of the present disclosure is detailed below.

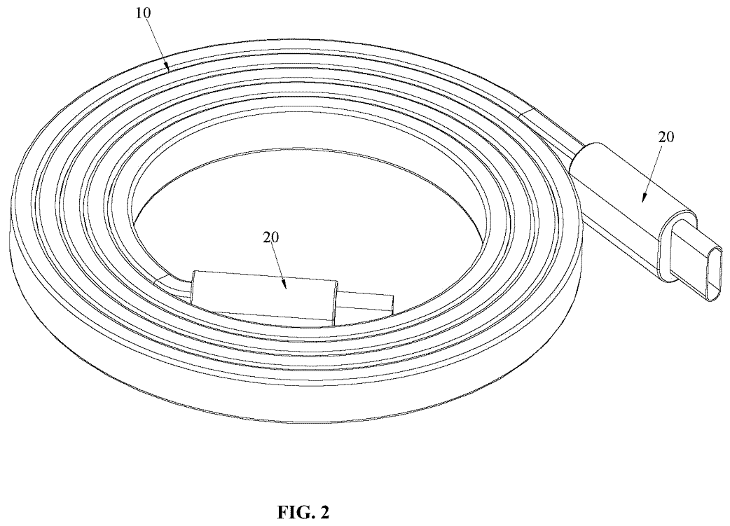

FIG. 1 and FIG. 2 show a coiling state of the magnetic data cable of the present disclosure. When the data cable is being coiled to form a coil, the flexible magnetic strip 13 is used for mutual magnetic attraction between the upper and lower layers of the cable body 10, or between adjacent layers of the cable body 10. Since the flexible magnetic strip 13 is continuously distributed in the external protective layer 12, it can adjust the size of the diameter of the coil after the data cable has been coiled without being obstructed, and also without being limited by the distance of the magnetic suction portions (or magnet block, or magnet ring) in the existing technologies. Thus it is convenient to adjust diameter of the coil after the data cable has been coiled so as to facilitate storing of the data cable.

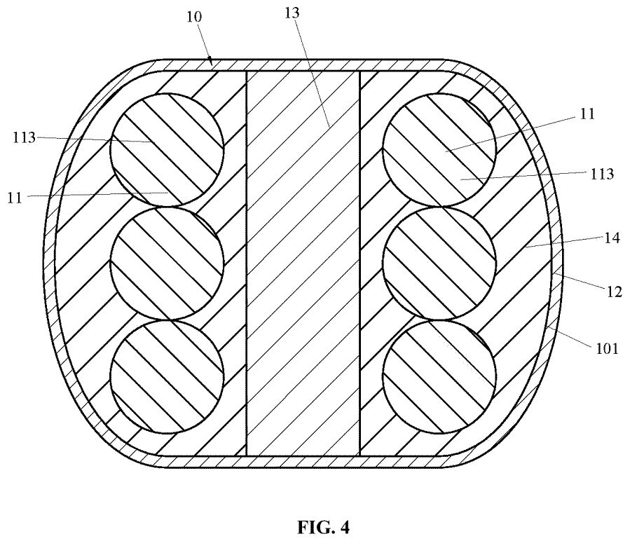

Referring to FIG. 4, it shows a specific structure of a magnetic data cable in accordance with a second preferred embodiment of the present disclosure. The specific structure of this embodiment is essentially the same as the specific structure of the magnetic data cable in the above first preferred embodiment, but with the following differences.

In this embodiment, the flexible magnetic strip 13 separates the external protective layer 12 to form two chambers 101, the cored wire group 11 is provided with two, and two cored wire groups 11 are located in the two chambers 101 respectively. And specifically, the cored wire group 11 includes a plurality of cored wires 113 arranged side by side, and plastic 14 is filled between an outer wall of the plurality of cod wires 113 and an inner wall of the chambers 101 to make the data cable fuller and more substantial. Furthermore, each cored wire group 11 has three cored wire 113, and each cored wire 113 is a round wire, but not limited to this.

The method for using the magnetic data cable in this embodiment is essentially the same as the method for using the magnetic data cable in the first preferred embodiment, thus the method for using the magnetic data cable in this embodiment is not described in detail herein.

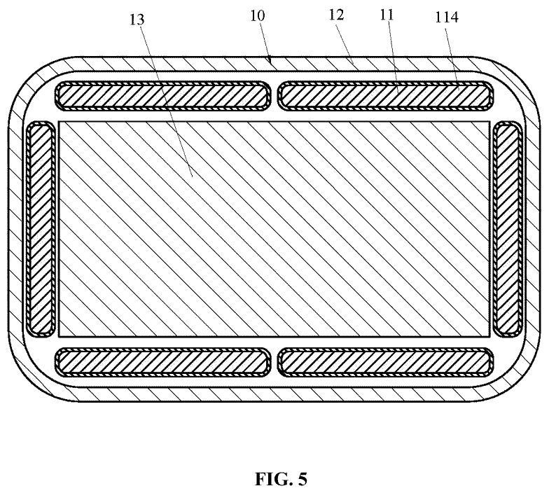

Referring to FIG. 5, it shows a specific structure of a magnetic data cable in accordance with a third preferred embodiment of the present disclosure. The specific structure of this embodiment is essentially the same as the specific structure of the magnetic data cable in the above first preferred embodiment, but with the following differences.

In this embodiment, the cored wire group 11 includes a plurality of flattened cored wires 114, and the flattened cored wires 114 are arranged around outer peripheral sides of the flexible magnetic strip 13. And, the flattened cored wires 114 are provided with six, all of which are distributed on the outer peripheral sides of the flexible magnetic strip 13, but not limited to this.

The method for using the magnetic data cable in this embodiment is essentially the same as the method for using the magnetic data cable in the first preferred embodiment, thus the method for using the magnetic data cable in this embodiment is not described in detail herein.

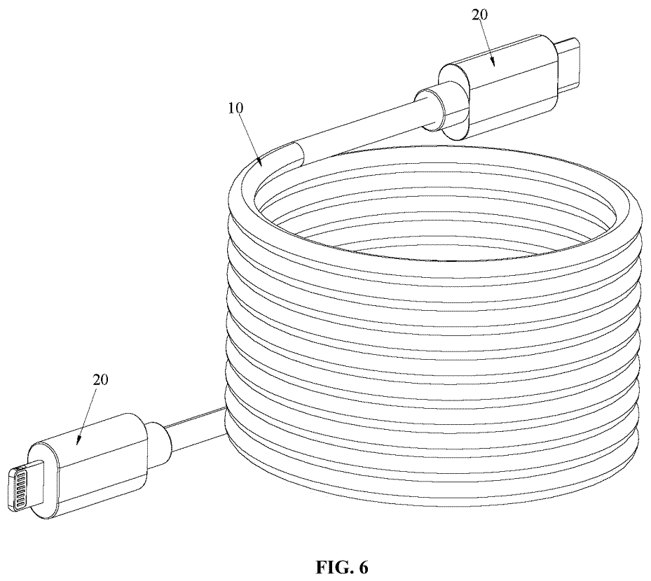

Referring to FIG. 6, it shows a specific structure of a magnetic data cable in accordance with a fourth preferred embodiment of the present disclosure. The specific structure of this embodiment is essentially the same as the specific structure of the magnetic data cable in the above first preferred embodiment, but with the following differences.

In this embodiment, the cable body 10 has a circular cross-section, which, after been coiled, is vertically arranged with multiple layers by means of stacking the upper and lower layers.

The design of the magnetic data cable of the present disclosure focuses on the following. By setting of the flexible magnetic strip in the external protective layer, so as to make the flexible magnetic strip locate alongside of the cored wire group and extend parallel to the cored wire group. When coiling the data cable to form a coil, the upper and lower layers of the cable body, or adjacent layers of the cable body are mutual magnetic attraction by means of the flexible magnetic strip. Since the flexible magnetic strip extends parallel to the cored wire group, it can adjust the size of the diameter of the coil after the data cable has been coiled without being obstructed, and also without being limited by the distance of the magnetic suction portions (or magnet block, or magnet ring) in the existing technologies. Thus it is convenient to adjust diameter of the coil after the data cable has been coiled so as to facilitate storing of the data cable, and it is easy to operate.

The foregoing descriptions have been described the technical principles of the present disclosure in conjunction with the specific embodiments. However, these descriptions are intended only to explain the principles of the present invention and are not to be construed in any way as a limitation on the scope of protection of the present invention. Based on the explanations herein, other specific embodiments of the present invention can be associated by one person ordinarily skill in the art without creative labor, which shall all fall within the scope of the protection of the present invention.

1. A magnetic data cable, comprising a cable body and a data interface connected to both ends of the cable body;
wherein the cable body comprises a cored wire group and an external protective layer wrapped outside of the cored wire group;
wherein a flexible magnetic strip is provided in the external protective layer, and the flexible magnetic strip is located alongside of the cored wire group and extends parallel to the cored wire group;
wherein the cored wire group is provided with two, and the flexible magnetic strip is located between the two cored wire groups; and
wherein the cored wire group comprises an inner protective layer and a plurality of cored wires disposed within the inner protective layer, and the number of the cored wires in the cored wire group is 2 to 4.

2. (canceled)

3. The magnetic data cable according to claim 1, wherein the cable body has a rectangular cross-section, each of the two cored wire groups has a circular cross-section, and the flexible magnetic strip has a rectangular cross-section.

4. (canceled)

5. The magnetic data cable according to claim 1, wherein the inner protective layer is made of plastic.

6. The magnetic data cable according to claim 1, wherein the external protective layer is a woven mesh layer formed by weaving fabrics.

7. The magnetic data cable according to claim 1, wherein the flexible magnetic strip separates the external protective layer to form two chambers, the cored wire group is provided with two, and two cored wire groups are located in the two chambers respectively.

8. The magnetic data cable according to claim 7, wherein the cored wire group comprises a plurality of cored wires arranged side by side, and plastic is filled between an outer wall of the plurality of cod wires and an inner wall of the chambers.

9. The magnetic data cable according to claim 1, wherein the cored wire group comprises a plurality of flattened cored wires, and the flattened cored wires are arranged around outer peripheral sides of the flexible magnetic strip.

10. The magnetic data cable according to claim 1, wherein the data interface is a USB Type-C data interface, a lightning data interface, or an Audio data interface.
